(19) United States
(12) Patent Application Publication
(10) Pub. No.: US 2023/0002538 A1
(43) Pub. Date: Jan. 5, 2023

(54) AQUEOUS POLYURETHANE DISPERSIONS

(71) Applicant: Covestro Intellectual Property GmbH & Co. KG, Leverkusen (DE)

(72) Inventors: Zhirong Fan, Langenfeld (DE); Shifeng Tang, Xuancheng City, Anhui Province (CN); Yun Chu, Pudong, Shanghai (CN); Shuguang Zheng, Pudong, Shanghai (CN)

(21) Appl. No.: 17/762,119

(22) PCT Filed: Sep. 23, 2020
(86) PCT No.: PCT/EP2020/076473

§ 371 Date: Mar. 21, 2022

(30) Foreign Application Priority Data
Sep. 30, 2019 (CN) 201910948793.2

(51) Int. Cl. C08G 18/12; C08G 18/48; C08G 18/32; C08K 5/42; C08K 5/17; C08J 5/24

(52) U.S. Cl. CPC C08G 18/12; C08G 18/4854; C08G 18/3221; C08K 5/42; C08K 5/17; C08J 5/24; C08G 2150/00; C08G 2170/00; C08G 2190/00; C08J 2375/08

(57) ABSTRACT

The present invention relates to an aqueous polyurethane dispersion, a method for the preparation thereof, a product comprising the same, and use thereof for a coating composition, an impregnating composition, an adhesive or a sealant. The aqueous polyurethane dispersion comprises a polyurethane obtained by reacting a system comprising the following components: A1) at least one polyisocyanate having an isocyanate functionality of not less than 2; A2) at least two different polytetramethylene ether glycols A2a) and A2b), the A2a) having a number average molecular weight of not more than 1500 g/mol, the A2b) having a number average molecular weight of more than 1500 g/mol; and A3) at least one anionic or potentially anionic hydrophilic agent having a number average molecular weight of 32 g/mol to 400 g/mol and containing hydroxyl and carboxyl functions; B) at least one amino-functional anionic or potentially anionic hydrophilic agent; and C) at least one amino-functional compound having a number average molecular weight of 32 g/mol to 400 g/mol and containing no hydrophilic group; wherein the ratio of the number average molecular weight of the A2a) to the number average molecular weight of the A2b) is 1:9 to less than 1:1, and the weight of the A3) amounts to 20% to 70% of the weight of the hydrophilic agents of the system, wherein the hydrophilic agents of the system are components A3 and B.

### TECHNICAL FIELD

The present invention relates to an aqueous polyurethane dispersion, a method for the preparation thereof, a product comprising the same, and use thereof for a coating composition, an impregnating composition, an adhesive or a sealant, as well as an article comprising a substrate prepared, coated, impregnated, bonded or sealed therewith.

### BACKGROUND

The aqueous polyurethane dispersion is a polyurethane system with water as the dispersion medium, and characterized in that it is non-polluting, safe and reliable, and has excellent mechanical properties. It is an important direction for the development of the polyurethane industry and can be widely used in the fields such as coating materials, adhesives, fabric coatings and fabric finishing agents, leather finishes and paper surface treatments.

Aqueous polyurethane dispersions are often used to coat textile carriers and synthetic leather since they have good low-temperature flexibility and elasticity. Of particular importance in this case is that the dispersion has a quite low tendency to hydrolyze and a relatively good mechanical strength. In the application field of synthetic leather, especially microfiber synthetic leather, it is required that the film formed by the dispersion has good tolerance in an acid-base environment. Although aqueous polyurethane dispersions have a wide range of adjustable properties, it is not always possible to obtain products with desirable performance characteristics. A disadvantage of the film formed by the existing aqueous polyurethane dispersion is that it cannot simultaneously satisfy good mechanical properties and acid and alkali resistance.

WO 07022885 discloses an elastomeric polyurethane dispersion composed of polyester polyols and having a high proportion of ethylene glycol and/or diethylene glycol. However, the product has a low hydrolysis resistance due to the instability of its ester bond, and thus the film formed by the dispersion is inferior in acid and alkali resistance.

DE 10122444 discloses an aqueous polyurethane dispersion based on polycarbonate and polytetramethylene glycol based polymer polyols, which exhibits high elasticity. However, the film formed by the dispersion has a low modulus and poor mechanical properties.

WO 06075144 discloses a polyurethane solution composed of diisocyanate(s), polytetramethylene glycol polyether polyol(s) and polyimine(s), which forms a film exhibiting high elasticity. However, the product is a solvent based polyurethane and is not an environmentally friendly product.

WO 2010142393 describes an aqueous polyurethane dispersion composed of diisocyanates and polytetramethylene glycol polyether polyols, which forms a film exhibiting good elasticity and resilience, but unsatisfactory acid and alkali resistance.

EP 2356163 discloses an aqueous polyurethane dispersion based on polyester polyol(s) and modified by carboxylic groups, which can be crosslinked with carbodiimide and exhibit good adhesion properties, but worse hydrolysis resistance and unsatisfactory acid and alkali resistance.

EP 3502156 A1 discloses an adhesive comprising an amorphous aqueous polyurethane dispersion and a carbodiimide crosslinkable therewith, wherein the aqueous polyurethane dispersion is obtained by reacting the components including an aliphatic polyisocyanate, a polyether polyol, an amino-functional chain extender and a hydrophilic agent, and the polyurethane of the aqueous polyurethane dispersion has carboxyl groups or carboxylate groups.

Therefore, the industry, especially the textile industry, such as in the field of microfiber synthetic leather, requires an aqueous polyurethane dispersion which forms a film having good mechanical properties and acid and alkali resistance.

### SUMMARY OF THE INVENTION

The term “curing” refers to the process from a liquid state to a solidified state.

The term “adhesive” refers to a mixture comprising a curable and viscous chemical component, and is also used as a synonym for a tackiness agent and/or a sealant and/or a binder.

The term “polyurethane” refers to polyurethaneurea and/or polyurethane polyurea and/or polyurea and/or polythiourethane.

The term “impregnation” refers to that a liquid penetrates into a flexible absorber which may be an absorber based on polyvinyl chloride, polyvinylidene chloride, nylon, polypropylene, polyester, cellulose, polyacrylamide, polyurethane and the like as the raw material.

It is an object of the present invention to provide an aqueous polyurethane dispersion, a method for the preparation thereof, a product comprising the same, and use thereof for a coating composition, an impregnating composition, an adhesive or a sealant, as well as an article comprising a substrate prepared, coated, impregnated, bonded or sealed therewith.

An aqueous polyurethane dispersion according to the present invention comprises a polyurethane obtained by reacting a system comprising the following components:

A1) at least one polyisocyanate having an isocyanate functionality of not less than 2;

A2) at least two different polytetramethylene ether glycols A2a) and A2b), the A2a) having a number average molecular weight of not more than 1500 g/mol, the A2b) having a number average molecular weight of more than 1500 g/mol; and

A3) at least one anionic or potentially anionic hydrophilic agent having a number average molecular weight of 32 g/mol to 400 g/mol and containing hydroxyl and carboxyl functions;

B) at least one amino-functional anionic or potentially anionic hydrophilic agent;

C) at least one amino-functional compound having a number average molecular weight of 32 g/mol to 400 g/mol and containing no hydrophilic group; and

D) optionally a neutralizer;

wherein the ratio of the number average molecular weight of the A2a) to the number average molecular weight of the A2b) is 1:9 to less than 1:1, and the weight of the A3) anionic or potentially anionic hydrophilic agent having a number average molecular weight of 32 g/mol to 400 g/mol and containing hydroxyl and carboxyl functions amounts to 20% to 70% of the weight of the hydrophilic agents of the system, wherein the hydrophilic agents of the system are components A3 and B.

In one aspect of the invention, there is provided a method for preparing an aqueous polyurethane dispersion provided in accordance with the present invention, comprising the steps of:

I) mixing and reacting A1) at least one polyisocyanate having an isocyanate functionality of not less than 2; A2) at least two different polytetramethylene ether glycols A2a) and A2b), the A2a) having a number average molecular weight of not more than 1500 g/mol, the A2b) having a number average molecular weight of more than 1500 g/mol; and A3) at least one anionic or potentially anionic hydrophilic agent having a number average molecular weight of 32 g/mol to 400 g/mol and containing hydroxyl and carboxyl functions to obtain an isocyanate-functional prepolymer;

II) reacting the isocyanate-functional prepolymer, B) at least one amino-functional anionic or potentially anionic hydrophilic agent, C) at least one amino-functional compound having a number average molecular weight of 32 g/mol to 400 g/mol and containing no hydrophilic group and D) an optional neutralizer to obtain a polyurethane; and

III) introducing water before, during or after step II) to obtain the aqueous polyurethane dispersion.

In one aspect of the invention, there is provided a product comprising an aqueous polyurethane dispersion provided in accordance with the present invention.

In one aspect of the invention, there is provided the use of an aqueous polyurethane dispersion provided in accordance with the present invention for a coating composition, an impregnating composition, an adhesive or a sealant.

In one aspect of the invention, there is provided the use of an aqueous polyurethane dispersion provided in accordance with the present invention for a coating composition, an impregnating composition, an adhesive or a sealant on a fiber-based substrate.

In one aspect of the invention, there is provided an article comprising a substrate prepared, coated, impregnated, bonded or sealed with an aqueous polyurethane dispersion provided in accordance with the present invention.

The aqueous polyurethane dispersion of the present invention is prepared by reacting a system comprising two different polytetramethylene ether glycols and two different hydrophilic agents, and the film obtained from the product comprising the aqueous polyurethane dispersion of the present invention has good mechanical properties and acid and alkali resistance. The aqueous polyurethane dispersion of the present invention is particularly suitable for the harsh conditions of the microfiber impregnation process: the hot alkali conditions of the splitting process and the hot acid conditions of the dyeing process (pH<6).

### DETAILED DESCRIPTION

The aqueous polyurethane dispersion provided by the present invention comprises a polyurethane obtained by reacting a system comprising the following components: A1) at least one polyisocyanate having an isocyanate functionality of not less than 2; A2) at least two different polytetramethylene ether glycols A2a) and A2b), the A2a) having a number average molecular weight of not more than 1500 g/mol, the A2b) having a number average molecular weight of more than 1500 g/mol; and A3) at least one anionic or potentially anionic hydrophilic agent having a number average molecular weight of 32 g/mol to 400 g/mol and containing hydroxyl and carboxyl functions; B) at least one amino-functional anionic or potentially anionic hydrophilic agent; C) at least one amino-functional compound having a number average molecular weight of 32 g/mol to 400 g/mol and containing no hydrophilic group; and D) optionally a neutralizer; wherein the ratio of the number average molecular weight of the A2a) to the number average molecular weight of the A2b) is 1:9 to less than 1:1, and the weight of the A3) anionic or potentially anionic hydrophilic agent having a number average molecular weight of 32 g/mol to 400 g/mol and containing hydroxyl and carboxyl functions amounts to 20% to 70% of the weight of the hydrophilic agents of the system, wherein the hydrophilic agents of the system are components A3 and B. The present invention also provides a method for preparing the aqueous polyurethane dispersion, a product comprising the same, and use thereof for a coating composition, an impregnating composition, an adhesive or a sealant, as well as an article comprising a substrate prepared, coated, impregnated, bonded or sealed therewith.

A1) Polyisocyanate

The polyisocyanate has an isocyanate functionality of preferably 2 to 4, further preferably 2 to 2.6, more preferably 2 to 2.4, and most preferably 2.

The polyisocyanate is preferably one or more of the followings: an aliphatic polyisocyanate and an alicyclic polyisocyanate; further preferably one or more of the followings: 1,4-butylene diisocyanate, hexamethylene diisocyanate (HDI), isophorone diisocyanate (IPDI), 2,2,4- and/or 2,4,4-trimethyl-hexamethylene diisocyanate, isomeric bis(4,4′-isocyanatocyclohexyl)methanes, 1,4-cyclohexylene diisocyanate, 1,4-phenylene diisocyanate, 2,4-toluene diisocyanate, 2,6-toluene diisocyanate, 1,5-naphthylene diisocyanate, 2,2′-diphenylmethane diisocyanate, 2,4′-diphenylmethane diisocyanate, 4,4′-diphenylmethane diisocyanate, 1,3-bis(2-isocyanatoprop-2-yl)benzene (TMXDI), 1,4-bis(2-isocyanatoprop-2-yl)benzene (TMXDI), 1,3-bis(isocyanatomethyl)benzene (XDI), C1-C8-alkyl 2,6-diisocyanatohexanoate (lysine diisocyanate) and derivatives thereof having uretdione, isocyanurate, urethane, allophanate, biuret, iminooxadiazinedione and/or oxadiazinetrione structure; and most preferably one or more of the followings: hexamethylene diisocyanate and isophorone diisocyanate.

According to the present invention, component A1 is preferably a mixture of at least two polyisocyanates having an isocyanate functionality of preferably 2 to 4, further preferably 2 to 2.6, more preferably 2 to 2.4, and most preferably 2. Particularly preferred a mixture of two polyisocyanates is used according to the present invention, more preferably a mixture of hexamethylene diisocyanate (HDI) and isophorone diisocyanate (IPDI) is used as component A1.

The amount of the polyisocyanate or of the mixture of at least two polyisocyanate is preferably 5 wt % to 40 wt %, further preferably 5 wt % to 35 wt %, and most preferably 5 wt % to 30 wt %, based on the amount of the system as 100 wt %.

Polytetramethylene Ether Glycols A2a) and A2b)

The polytetramethylene ether glycols A2a) and A2b) of the present invention each independently correspond to the general formula: (HO—(CH₂—CH₂—CH₂—CH₂—O)ₓ—H).

The polytetramethylene ether glycols (polytetramethylene glycol polyethers) can be obtained by the cationic ring-opening polymerization of tetrahydrofuran, for example.

The polytetramethylene ether glycol A2a) has a number average molecular weight of preferably 400 g/mol to 1500 g/mol, further preferably 600 g/mol to 1200 g/mol, and most preferably 1000 g/mol.

The polytetramethylene ether glycol A2b) has a number average molecular weight of preferably more than 1500 g/mol and less than or equal to 8000 g/mol, further preferably 1800 g/mol to 4000 g/mol, and most preferably 2000 g/mol.

The ratio of the number average molecular weight of the polytetramethylene ether glycol A2a) to the number average molecular weight of the polytetramethylene ether glycol A2b) is 1:4 to less than 1:1, most preferably 1:4 to less than 1:1.

The number average molecular weight is determined by gel permeation chromatography in tetrahydrofuran at 23° C. against polystyrene standards.

The mass ratio of the polytetramethylene ether glycol A2a) to the polytetramethylene ether glycol A2b) is preferably 1:15 to less than 1:1, most preferably 1:10 to less than 1:1.

The amount of the A2) polytetramethylene ether glycols is preferably 55 wt % to 90 wt %, further preferably 60 wt % to 90 wt %, and most preferably 65 wt % to 90 wt %, based on the amount of the system as 100 wt %.

A3) Anionic or Potentially Anionic Hydrophilic Agent Having a Number Average Molecular Weight of 32 g/Mol to 400 g/Mol and Containing Hydroxyl and Carboxyl Functions.

According to the present invention component A3 is a hydrophilic agent of the system.

The A3) is preferably dimethylolpropionic acid.

The weight of the A3) anionic or potentially anionic hydrophilic agent having a number average molecular weight of 32 g/mol to 400 g/mol and containing hydroxyl and carboxyl functions amounts to preferably 20% to 60%, further preferably 20% to 35%, and most preferably 20% to 30% of the weight of the hydrophilic agents of the system.

A4) Another Polymer Polyol

The system may further comprise a polymer polyol other than the A2) polytetramethylene polyether glycols.

The polymer polyol is preferably one or more of the followings: polyester polyol, polyacrylate polyol, polyurethane polyol, polycarbonate polyol, polyether polyol, polyester polyacrylate polyol, polyurethane polyacrylate polyol, polyurethane polyester polyol, polyurethane polyether polyol, polyurethane polycarbonate polyol and polyester polycarbonate polyol.

The content of the polymer polyol is preferably 0 to 20 wt %, further preferably 0 to 15 wt %, based on the A2) polytetramethylene ether glycols.

A5) Hydroxyl-Functional Compound Having a Number Average Molecular Weight of 62 to 399 g/Mol

The system may further comprise a hydroxyl-functional compound having a number average molecular weight of 62 to 399 g/mol.

The hydroxyl-functional compound having a number average molecular weight of 62 to 399 g/mol is preferably one or more of the followings: a non-polymer polyol having up to 20 carbon atoms, an ester diol and a monofunctional isocyanate-reactive hydroxyl group-containing compound.

The non-polymer polyol having up to 20 carbon atoms is preferably one or more of the followings: ethylene glycol, diethylene glycol, triethylene glycol, 1,2-propylene glycol, 1,3-propylene glycol, 1,4-butanediol, 1,3-butanediol, cyclohexanediol, 1,4-cyclohexanedimethanol, 1,6-hexanediol, neopentyl glycol, hydroquinone dihydroxylethylether, bisphenol A (2,2-bis(4-hydroxylphenyl)propane), hydrogenated bisphenol A (2,2-bis(4-hydroxylcyclohexyl)propane), trimethylolpropane, trimethylolethane, glycerol, and pentaerythritol.

The ester diol is preferably one or more of the followings: α-hydroxylbutyl-ε-hydroxyl hexanoate, ω-hydroxylhexyl-γ-hydroxyl butyrate, (β-hydroxylethyl) adipate and di(β-hydroxylethyl) terephthalate.

The monofunctional isocyanate-reactive hydroxyl group-containing compound is preferably one or more of the followings: ethanol, n-butanol, ethylene glycol monobutyl ether, diethylene glycol monomethyl ether, diethylene glycol monobutyl ether, propylene glycol monomethyl ether, dipropylene glycol monomethyl ether, tripropylene glycol monomethyl ether, tripropylene glycol monopropyl ether, propylene glycol monobutyl ether, dipropylene glycol monobutyl ether, tripropylene glycol monobutyl ether, 2-ethylhexanol, 1-octanol, 1-dodecanol and 1-hexadecanol.

The amount of the hydroxyl-functional compound having a number average molecular weight of 62 to 399 g/mol is preferably 0 to 10 wt %, most preferably 0 to 5 wt %, based on the solid weight of the aqueous polyurethane dispersion as 100 wt %.

A6) Isocyanate-Reactive Nonionic Hydrophilic Agent

The system may further comprise an isocyanate-reactive nonionic hydrophilic agent. According to the present invention component A6 is a hydrophilic agent of the system. In case that component A6 is present, hydrophilic agents of the system are components A3, B and A6.

The isocyanate-reactive nonionic hydrophilic agent is preferably one or more of the followings: a polyoxyalkylene ether having hydroxyl groups, a polyoxyalkylene ether having amino groups and a polyoxyalkylene ether having thiol groups.

The isocyanate-reactive nonionic hydrophilic agent is most preferably a monohydroxy-functional polyalkylene oxide polyether alcohol having a statistical average of preferably 5 to 70, particularly preferably 7 to 55 ethylene oxide units per molecule, as can be obtained in a known manner by alkoxylation of a suitable starting molecule (e.g. in Ullmanns Encyclopadie der technischen Chemie, 4th edition, vol. 19, Verlag Chemie, Weinheim pp. 31-38). The monohydroxy-functional polyalkylene oxide polyether alcohol preferably has 40 to 100 mol % of ethylene oxide units and 0 to 60 mol % of propylene oxide units.

The starting molecule is preferably a saturated monoalcohol, a diethylene glycol monoalkyl ether, an unsaturated alcohol, an aromatic alcohol, an araliphatic alcohol, a secondary monoamine and a heterocyclic secondary amine, and most preferably a saturated monoalcohol.

The saturated monoalcohol is preferably one or more of the followings: methanol, ethanol, n-propanol, isopropanol, n-butanol, isobutanol, sec-butanol, isomeric pentanols, hexanols, octanols and nonanols, n-decanol, n-dodecanol, n-tetradecanol, n-hexadecanol, n-octadecanol, cyclohexanol, isomeric methylcyclohexanols, hydroxymethylcyclohexane, 3-ethyl-3-hydroxymethyloxetane, tetrahydrofurfuryl alcohol and a diethylene glycol monoalkyl ether; and most preferably one or more of the followings: n-butanol and diethylene glycol monobutyl ether.

The unsaturated alcohol is preferably one or more of the followings: allyl alcohol, 1,1-dimethyl allyl alcohol and oleic alcohol.

The aromatic alcohol is preferably one or more of the followings: phenol, isomeric cresols and methoxyphenols.

The araliphatic alcohol is preferably one or more of the followings: benzyl alcohol, anisyl alcohol and cinnamyl alcohol.

The secondary monoamine is preferably one or more of the followings: dimethylamine, diethylamine, dipropylamine, diisopropylamine, dibutylamine, bis(2-ethylhexyl)amine, N-methylcyclohexylamine, N-ethylcyclohexylamine and dicyclohexylamine.

The heterocyclic secondary amine is preferably one or more of the followings: morpholine, pyrrolidine, piperidine and 1H-pyrazole.

B) Amino-Functional Anionic or Potentially Anionic Hydrophilic Agent

The B) amino-functional anionic or potentially anionic hydrophilic agent preferably contains one or more groups of the followings: a sulfonic acid group, a sulfonate group, a carboxylic acid group, and a carboxylate group, and most preferably contains a sulfonate group. The sulfonate group is preferably sodium sulfonate group.

According to the Present Invention Component B is a Hydrophilic Agent of the System.

The B) amino-functional anionic or potentially anionic hydrophilic agent is preferably one or more of the followings: an alkali metal salt of monoaminosulfonic acids, an alkali metal salt of diaminosulfonic acids, a diaminocarboxylic acid and a diaminocarboxylate; further preferably one or more of the followings: a compound containing a sulfonate group as the ionic group and two amino groups, a compound containing a carboxylic acid group as the ionic group and two amino groups, and a compound containing a carboxylate group as the ionic group and two amino groups; more preferably one or more of the followings: 2-[(2-aminoethyl)amino]ethane sulfonate, 1,3-propanediamine-β-ethane sulfonate, diaminocarboxylate and 2,6-diaminocarboxylic acid; still preferably one or more of the followings: 2-[(2-aminoethyl)amino]ethanesulfonate, ethanediaminepropylsulfonate, ethanediaminebutylsulfonate, 1,2-propanediamine-β-ethanesulfonate, 1,2-propanediamine-β-taurate, 1,3-propanediamine-β-ethanesulfonate, 1,3-propanediamine-β-taurate, cyclohexylaminopropanesulfonate (CAPS), sodium diaminocarboxylate and 2,6-diaminohexanoic acid; and most preferably sodium 2[(2-aminoethyl)amino]ethanesulfonate.

C) Amino-Functional Compound Having a Number Average Molecular Weight of 32 g/Mol to 400 g/Mol and Containing No Hydrophilic Group

The amino-functional compound having a number average molecular weight of 32 g/mol to 400 g/mol and containing no hydrophilic group is preferably an amine without any ionic group or ionized group.

The amine without any ionic group or ionized group is preferably one or more of the followings: an organic diamine, an organic polyamine, a primary/secondary amine, an alkanolamine and a monofunctional isocyanate-reactive amine compound.

The organic diamine or organic polyamine is preferably one or more of the followings: 1,2-ethanediamine, 1,2-diaminopropane, 1,3-diaminopropane, 1,4-diaminobutane, 1,6-diaminohexane, isophorone diamine, 2,2,4-trimethyl-hexamethylenediamine, 2,4,4-trimethyl-hexamethylenediamine, 2-methylpentamethylenediamine, diethylenetriamine, 4,4-diaminodicyclohexylmethane, hydrazine hydrate and dimethylethanediamine.

The primary/secondary amine is preferably one or more of the followings: diethanolamine, 3-amino-1-methylaminopropane, 3-amino-1-ethylaminopropane, 3-amino-1-cyclohexylaminopropane and 3-amino-1-methylaminobutane.

The alkanolamine is preferably one or more of the followings: N-aminoethylethanolamine, ethanolamine, 3-aminopropanol and neopentanolamine.

The monofunctional isocyanate-reactive amine compound is preferably one or more of the followings: methylamine, ethylamine, propylamine, butylamine, octylamine, laurylamine, stearylamine, isononoxypropylamine, dimethylamine, diethylamine, dipropylamine, dibutylamine, N-methylaminopropylamine, diethyl(methyl)aminopropylamine, morpholine, piperidine and suitably substituted derivatives thereof such as an amido-amine formed from a di-primary amine and a monocarboxylic acid, and a monoketo-imide of a di-primary amine or a primary/tertiary amine.

The amine without any ionic group or ionized group is most preferably one or more of the followings: 1,2-ethanediamine, di(4-aminocyclohexyl)methane, 1,4-diaminobutane, isophorone diamine, ethanolamine, diethanolamine and diethylene triamine.

The sum of the weights of the A5) and the C) is preferably 0.5 wt % to 20 wt %, further preferably 0.5 wt % to 15 wt %, and most preferably 0.5 wt % to 14 wt %, based on the amount of the system as 100 wt %.

The sum of the weights of the A6) and the B) is preferably 0.1 wt % to 25 wt %, further preferably 0.1 wt % to 15 wt %, and most preferably 0.1 wt % to 13.5 wt %, based on the amount of the system as 100 wt %.

Neutralizer

The molar amount of the neutralizer is preferably less than or equal to 50 mol %, most preferably less than or equal to 30 mol %, based on the molar amount of the A3) anionic or potentially anionic hydrophilic agent having a number average molecular weight of 32 g/mol to 400 g/mol and containing hydroxyl and carboxyl functions as 100 mol %.

The neutralizer is preferably one or more of the followings: ammonia, ammonium carbonate, ammonium bicarbonate, trimethylamine, triethylamine, tributylamine, diisopropylethylamine, dimethylethanolamine, diethylethanolamine, triethanolamine, lithium hydroxide, sodium hydroxide, potassium hydroxide, dimethyl ether sulfate, succinic acid and sodium carbonate; and most preferably one or more of the followings: triethylamine, triethanolamine, dimethylethanolamine, sodium hydroxide, potassium hydroxide, diisopropylethylamine, dimethyl ether sulfate and succinic acid.

Method

The method for preparing an aqueous polyurethane dispersion of the present invention preferably comprises the steps of:

I) mixing and reacting A1) at least one polyisocyanate having an isocyanate functionality of not less than 2; A2) at least two different polytetramethylene ether glycols A2a) and A2b), the A2a) having a number average molecular weight of not more than 1500 g/mol, the A2b) having a number average molecular weight of more than 1500 g/mol; A3) at least one anionic or potentially anionic hydrophilic agent having a number average molecular weight of 32 g/mol to 400 g/mol and containing hydroxyl and carboxyl functions; A4) optional another polymer polyol; A5) an optional hydroxyl-functional compound having a number average molecular weight of 62 to 399 g/mol; and A6) an optional isocyanate-reactive nonionic hydrophilic agent to obtain an isocyanate-functional prepolymer;

II) reacting the isocyanate-functional prepolymer, B) at least one amino-functional anionic or potentially anionic hydrophilic agent, C) at least one amino-functional compound having a number average molecular weight of 32 g/mol to 400 g/mol and containing no hydrophilic group and D) an optional neutralizer to obtain a polyurethane; and

III) introducing water before, during or after step II) to obtain the aqueous polyurethane dispersion.

The preparation of the aqueous polyurethane dispersion can be carried out in one or more steps in a homogeneous phase, or carried out in a multi-step reaction, partially in a dispersed phase. After the polyaddition reaction of A1) to A6) is fully or partially finished, a dispersing, emulsifying or dissolving step is preferably carried out. Optionally, a further polyaddition or modification reaction in a dispersed phase is subsequently carried out.

The aqueous polyurethane dispersion can be prepared using any method known in the art, such as the prepolymer mixing process, the acetone process or the melt dispersion process, wherein the acetone process is most preferably used.

For the preparation using the acetone process, in general, components A1)-A6) are first fully or partially added, and optionally diluted with a water-miscible solvent which is inert to isocyanate groups, and heated to a temperature in the range from 50° C. to 120° C. to produce the isocyanate-functional prepolymer. The catalysts known in the polyurethane chemistry can be used to accelerate the isocyanate addition reaction.

The suitable solvent is a conventional aliphatic keto-functional solvent, such as acetone or 2-butanone, and can be added at the beginning of the preparation and optionally partially added afterwards. It is also possible to add other solvents without isocyanate-reactive groups.

The components A1) to A6) which have not been added are metered in optionally at the beginning of the reaction.

Upon preparation of the isocyanate-functional prepolymer in step I), the molar ratio of the isocyanate groups to the isocyanate-reactive groups is preferably 1.05 to 3.5, further preferably 1.1 to 3.0, and most preferably 1.1 to 2.5.

The reaction of the components A1) to A6) carried out to form a prepolymer in step I) can partially or completely take place, and preferably completely take place. In this way, an isocyanate-functional polyurethane prepolymer containing free isocyanate groups is obtained in the form of the bulk per se or a solution. The term “free” used herein includes both free and potentially free.

If the water for dispersion already contains the neutralizer, the neutralization reaction can also take place simultaneously with the dispersion.

In the subsequent processing steps, the isocyanate-functional prepolymer obtained is dissolved by using an aliphatic ketone, such as acetone or 2-butanone, if it is not or only partially dissolved.

The step II) is a chain extension and termination reaction, wherein the B) amino-functional anionic or potentially anionic hydrophilic agent, the C) amino-functional compound having a number average molecular weight of 32 g/mol to 400 g/mol and containing no hydrophilic group, and D) an optional neutralizer are reacted with the free isocyanate groups of the isocyanate-functional prepolymer obtained in the step I.

The extent to which the chain extension reaction of the step II) takes place, i.e., the equivalent ratio of the isocyanate-reactive groups of the compounds used for the chain extension and termination reaction to the free isocyanate groups is preferably 40% to 150%, further preferably 50% to 110%, and most preferably 60% to 100%.

In the step II), the components B) and C) can be used separately or in a mixture, optionally in the water- or solvent-diluted form, and added in any order which is in principle possible. If water or an organic solvent is used as the diluent, the amount of the diluent amounts to 40 wt % to 95 wt % of the amount of the components used for the chain extension in the step II).

The step II) is preferably carried out before the dispersion with water. For this purpose, the dissolved and chain-extended prepolymer can be added to water, optionally with application of strong shear, such as intensive stirring; or conversely, water is added to the dissolved and chain-extended polyurethane polymer under stirring. It is preferred to add water to the dissolved and chain-extended polyurethane polymer.

The solvent remaining in the dispersion is generally removed by distillation. The solvent may also be removed during the dispersing step.

The residual content of the organic solvent in the aqueous polyurethane dispersion prepared by the method of the present invention is preferably 0 to 10 wt %, most preferably 0 to 3 wt %, based on the amount of the aqueous polyurethane dispersion as 100 wt %.

The aqueous polyurethane dispersion has a pH value of preferably less than 8.0, further preferably less than 7.5, and most preferably 6.5 to 7.5.

The aqueous polyurethane dispersion has a solid content of preferably 30 wt % to 55 wt %, based on the amount of the aqueous polyurethane dispersion as 100 wt %.

The aqueous polyurethane dispersion preferably has a viscosity of 15 mPa·s to 4000 mPa·s.

The aqueous polyurethane dispersion preferably has a particle size of 50 nm to 7000 nm, most preferably 150 nm to 7000 nm.

Product

The product is preferably selected from the group consisting of a coating composition, an impregnating composition, an adhesive, and a sealant.

The product may comprise a crosslinking agent. The crosslinking agent is preferably one or more of the followings: a crosslinking agent having an isocyanate-reactive group and a crosslinking agent having a carboxyl-reactive group.

The crosslinking agent having an isocyanate-reactive group is preferably a hydrophilically modified aliphatic isocyanate crosslinking agent.

The crosslinking agent having a carboxyl-reactive group is preferably a hydrophilically modified carbodiimide.

The product may comprise an additive. The additive may be one or more of the followings: defoamers, thickeners, thixotropic agents, antioxidants, light stabilizers, emulsifiers, plasticizers, pigments, fillers, skein stabilizing additives, biocides, pH regulators, and flow control agents.

The amount of the additive is preferably 0 to 15 wt %, most preferably 0.01 wt % to 10 wt %, based on the amount of the product as 100 wt %.

Substrate

The coating is performed by applying the aqueous polyurethane dispersion to a substrate, for example, by using a knife, such as a coating knife, a roller or other equipments, or by means of spraying or dipping.

The coating can be applied on one or both sides of the substrate.

The substrate may be subject to a surface treatment, such as pre-coating, polishing, velveting, raising, and/or drum fulling and drying, before, during or after application of the aqueous polyurethane dispersion of the present invention.

The aqueous polyurethane dispersion of the present invention can also be applied to the substrate in the form of multi-layer coating.

The substrate is preferably fiber-based, and the fiber-based substrate may be synthetic fibers and/or natural fibers. Principally, the substrate made of any fibers is suitable for use in the method of the present invention.

The fiber-based substrate is preferably microfibers, most preferably microfiber nonwoven fabric or microfiber PU synthetic leather.

The microfibers may be sea-island two-component microfibers. The sea component and the island component of the sea-island two-component microfibers are different. The island component of the sea-island two-component microfibers can be a conventional polymer in the textile application, and is preferably one or more of the followings: ethylene terephthalate, modified polyesters such as polypropylene terephthalate, cationic polyesters, nylon, polyamides of other types, polyethylene, polypropylene, and polyolefins of other types. The sea component of the sea-island two-component microfibers can be a polymer that can be dissolved and removed by means of the treatment with water, an aqueous alkali solution or an aqueous acid solution and the like, and is preferably one or more of the followings: nylon, other polyamides, modified polyesters, and other spinnable polymers having the basic properties such as solubility in water, an aqueous acid solution or an aqueous alkali solution; further preferably one or more of the followings: alkali water-soluble polyesters and hot water-soluble polyvinyl alcohols; and most preferably one or more of the followings: alkali water-soluble polyhydroxyalkanoates (PHAs) and hot water-soluble polyvinyl alcohols (PVAs).

Article

The article is preferably synthetic leather, most preferably microfiber synthetic leather.

The article is preferably suitable for use in coats, synthetic leather, shoes, upholstery fabrics or interior fittings, the above list being by way of example only and not limiting.

The article comprises the film formed by curing the aqueous polyurethane dispersion on the substrate.

The film has a tensile strength at break of preferably not less than 20 N/mm², an elongation at break of preferably greater than 580%, a 100% modulus of preferably not less than 2.5 N/mm², and a swelling ratio of less than 32%.

### Examples

All technical and scientific terms used herein have the same meaning as commonly understood by those skilled in the art to which the present invention belongs, unless otherwise defined. When the definition of a term in the present description conflicts with the meaning as commonly understood by those skilled in the art to which the present invention belongs, the definition described herein shall apply.

All numerical values expressing amount of ingredients, reaction conditions and the like which are used in the description and claims are to be understood as being modified by the term “about”, unless otherwise specified. Accordingly, unless indicated to the contrary, the numerical values and parameters described herein are approximate values which can be varied according to the desired performance obtained as required.

The term “and/or” used herein refers to one or all of the elements mentioned.

The term “above” and “below” used herein encompass the recited values themselves, unless otherwise specified.

The terms “containing”, “including” and “comprising” used herein cover both the case that there are only the elements mentioned and the case that there are also other elements unmentioned in addition to the elements mentioned.

The analysis and measurement in the present invention are carried out at 23° C., unless otherwise specified.

All percentages in the present invention refer to weight percentage, unless otherwise specified.

The solid content of the aqueous polyurethane dispersion is determined using a HS153 moisture meter from the Mettler Toledo company in accordance with DIN-EN ISO 3251.

The number average molecular weight is determined with the gel permeation chromatography in tetrahydrofuran at 23° C. against the polystyrene standards.

The hydroxyl value is determined in accordance with ASTM D4274.

The isocyanate group (NCO) content is determined by volume in accordance with DIN-EN ISO 11909, and the determined data include the free and potentially free NCO contents.

The functionality of the isocyanate group is determined in accordance with GPC.

The particle size of the aqueous polyurethane dispersion is determined using the laser spectroscopy (measured with the Zatasizer Nano ZS 3600 laser particle sizer from the Malvern instrument company) after dilution with deionized water.

The viscosity of the aqueous polyurethane dispersion is measured at 23° C. in accordance with DIN 53019 using the DV-II+Pro. rotational viscometer from the Brookfield company.

The pH value of the aqueous polyurethane dispersion is measured at 23° C. using the PB-10 pH meter from the Sartorius company, Germany.

Raw Materials and Reagents

Desmodur® H: 1,6-hexamethylene diisocyanate, available from Covestro AG, Germany.

Desmodur® I: isophorone diisocyanate, available from Covestro AG, Germany.

Polytetramethylene ether glycol 1000: having a hydroxyl value of 112 mg KOH/g, a hydroxyl functionality of 2, and a number average molecular weight of 1000 g/mol, available from BASF, Germany.

Polytetramethylene ether glycol 2000: having a hydroxyl value of 56 mg KOH/g, a hydroxyl functionality of 2, and a number average molecular weight of 2000 g/mol, available from BASF, Germany.

Polytetramethylene ether glycol 4000: having a hydroxyl value of 28 mg KOH/g, a hydroxyl functionality of 2, and a number average molecular weight of 4000 g/mol, available from BASF, Germany.

Polycarbonate polyol 1: a polycarbonate polyol of hexanediol and dimethyl carbonate, having a hydroxyl value of 56 mg KOH/g and a number average molecular weight of 2000 g/mol, available from Covestro AG, Germany.

Polycarbonate polyol 2: a polycarbonate polyol of pentanediol mixed with hexanediol (in a molar ratio of 55:45) and dimethyl carbonate, having a hydroxyl value of 56 mg KOH/g and a number average molecular weight of 2000 g/mol, available from Covestro AG, Germany.

Polyether polyol 1: a propylene oxide-based polyether polyol, having a functionality of 2 and a number average molecular weight of 2000 g/mol, available from Covestro AG, Germany.

Polyether polyol 2: an ethylene oxide/propylene oxide-based monofunctional polyether polyol, having a number average molecular weight of 2250 g/mol, available from Covestro AG, Germany.

Polyether polyol 3: LP112, a propylene oxide-based polyether polyol, having a functionality of 2 and a number average molecular weight of 1000 g/mol, available from Covestro AG, Germany.

Dimethylolpropionic acid: available from Aldrich Chemicals, Germany.

Sodium 2[(2-aminoethyl)amino]ethanesulfonate solution: NH₂—CH₂CH₂—NH—CH₂CH₂—SO₃Na, having a concentration of 45% in water, available from Covestro AG, Germany.

Ethylenediamine available from Jiaxing Jinyan Chemical Co., Ltd., China.

Isophorone diamine available from Covestro AG, Germany.

Desmodur 2794: a hydrophilically modified aliphatic blocked isocyanate crosslinking agent, having a solid content of 38 wt %, an isocyanate group content of 12.7 wt % (based on the solid content), and a viscosity of <1500 mPa·s, available from Covestro AG.

Desmodur® 2802: a hydrophilically modified carbodiimide crosslinking agent, having a solid content of 40 wt %, and a NCN group content of 4.2 wt %, available from Covestro AG.

Sodium diaminocarboxylate solution: NH₂—CH₂CH₂—NH—CH₂CH₂—CO₂Na, having a concentration of 40 wt % in water, available from BASF, Germany.

Hydrazine hydrate: available from Aldrich Chemicals, Germany.

Potassium hydroxide: available from Sinopharm Chemical Reagent Co. Ltd., China, formulated into a 10% aqueous solution in the laboratory prior to use.

2,6-Diaminohexanoic acid: 50% solution, available from Xiamen Feihe Chemical Co. Ltd., China.

Sodium hydroxide: analytically pure, available from Sinopharm Chemical Reagent Co. Ltd.

Acetic acid: analytically pure, available from Kelin Reagent Co. Ltd.

Preparation of Aqueous Polyurethane Dispersions

Aqueous Polyurethane Aqueous Dispersion 1

1015 g of polytetramethylene ether glycol 2000, 217.5 g of polytetramethylene ether glycol 1000, 15.6 g of dimethylolpropionic acid, 144.4 g of Desmodur® I and 109.3 g of Desmodur® H were mixed at 70° C., heated to 110° C. and stirred at this temperature until the actual value of the isocyanate group (NCO) of the prepolymer was less than or equal to the theoretical NCO value. The prepolymer was dissolved in 2669.7 g of acetone at 90° C., stirred for 20 minutes and then cooled to 40° C. Then, 12.4 g of ethylenediamine, 50.2 g of sodium 2-[(2-aminoethyl)amino]ethanesulfonate solution and 310.1 g of water were added. After stirring for 20 minutes, 1967.3 g of water was further added for dispersion, and the solvent was removed by vacuum distillation to obtain the aqueous polyurethane aqueous dispersion 1 having a solid content of 41.8 wt %, a viscosity of 159 mPa·s (23° C.), a pH value of 6.7 and a particle size of 163.5 nm.

Aqueous Polyurethane Aqueous Dispersion 2

280 g of polytetramethylene ether glycol 2000, 60.0 g of polytetramethylene ether glycol 1000, 4.3 g of dimethylolpropionic acid, 79.7 g of Desmodur® I were mixed at 70° C., heated to 110° C. and stirred at this temperature until the actual NCO value of the prepolymer was less than or equal to the theoretical NCO value. The prepolymer was dissolved in 753.7 g of acetone at 90° C., stirred for 20 minutes and then cooled to 40° C. Then, 3.4 g of ethylenediamine, 13.8 g of sodium 2[(2-aminoethyl)amino]ethanesulfonate solution and 85.5 g of water were added. After stirring for 20 minutes, 557.3 g of water was further added for dispersion, and the solvent was removed by vacuum distillation to obtain the aqueous polyurethane dispersion 2 having a solid content of 41.4 wt %, a viscosity of 15 mPa·s (23° C.), a pH value of 6.6 and a particle size of 205.2 nm.

Aqueous Polyurethane Aqueous Dispersion 3

280 g of polytetramethylene ether glycol 2000, 60.0 g of polytetramethylene ether glycol 1000, 4.3 g of dimethylolpropionic acid and 60.3 g of Desmodur® H were mixed at 70° C., heated to 110° C. and stirred at this temperature until the actual NCO value of the prepolymer was less than or equal to the theoretical NCO value. The prepolymer was dissolved in 753.7 g of acetone at 90° C., stirred for 20 minutes and then cooled to 40° C. Then, 3.4 g of ethylenediamine, 13.8 g of sodium 2[(2-aminoethyl)amino]ethanesulfonate solution and 85.5 g of water were added. After stirring for 20 minutes, 528.3 g of water was added for dispersion, and the solvent was removed by vacuum distillation to obtain the aqueous polyurethane dispersion 3 having a solid content of 42.2 wt %, a viscosity of 122.0 mPa·s (23° C.), a pH value of 6.8 and a particle size of 216.3 nm.

Aqueous Polyurethane Aqueous Dispersion 4

280 g of polytetramethylene ether glycol 2000, 60.0 g of polytetramethylene ether glycol 1000, 4.3 g of dimethylolpropionic acid, 39.8 g of Desmodur® I and 30.1 g of Desmodur® H were mixed at 70° C., heated to 110° C. and stirred at this temperature until the actual NCO value of the prepolymer was less than or equal to the theoretical NCO value. The prepolymer was dissolved in 753.7 g of acetone at 90° C., with 0.65 g of TEA added, stirred for 20 minutes and then cooled to 40° C. Then, 3.4 g of ethylenediamine, 13.8 g of sodium 2-[(2-aminoethyl)amino]ethanesulfonate solution and 85.5 g of water were added. After stirring for 20 minutes, 543.7 g of water was further added for dispersion, and the solvent was removed by vacuum distillation to obtain the aqueous polyurethane dispersion 4 having a solid content of 30.2 wt %, a viscosity of 61 mPa·s (23° C.), a pH value of 7.1 and a particle size of 204.2 nm.

Aqueous Polyurethane Aqueous Dispersion 5

280 g of polytetramethylene ether glycol 2000, 60.0 g of polytetramethylene ether glycol 1000, 4.3 g of dimethylolpropionic acid, 39.8 g of Desmodur® I and 30.1 g of Desmodur® H were mixed at 70° C., heated to 110° C. and stirred at this temperature until the actual NCO value of the prepolymer was less than or equal to the theoretical NCO value. The prepolymer was dissolved in 753.7 g of acetone at 90° C., with 0.33 g of TEA added, stirred for 20 minutes and then cooled to 40° C. Then, 3.4 g of ethylenediamine, 13.8 g of sodium 2-[(2-aminoethyl)amino]ethanesulfonate solution and 85.5 g of water were added. After stirring for 20 minutes, 545.1 g of water was further added for dispersion, and the solvent was removed by vacuum distillation to obtain the aqueous polyurethane dispersion 5 having a solid content of 41.0 wt %, a viscosity of 46 mPa·s (23° C.), a pH value of 7.0 and a particle size of 179.0 nm.

Aqueous Polyurethane Aqueous Dispersion 6

350 g of polytetramethylene ether glycol 4000, 37.5 g of polytetramethylene ether glycol 1000, 2.7 g of dimethylolpropionic acid, 24.9 g of Desmodur® I and 18.8 g of Desmodur® H were mixed at 70° C., heated to 110° C. and stirred at this temperature until the actual NCO value of the prepolymer was less than or equal to the theoretical NCO value. The prepolymer was dissolved in 771.4 g of acetone at 90° C., stirred for 20 minutes and then cooled to 40° C. Then, 2.1 g of ethylenediamine, 8.6 g of sodium 2[(2-aminoethyl)amino]ethanesulfonate solution and 53.5 g of water were added. After stirring for 20 minutes, 601.7 g of water was added for dispersion, and the solvent was removed by vacuum distillation to obtain the aqueous polyurethane dispersion 6 having a solid content of 30.1 wt %, a viscosity of 1960 mPa·s (23° C.), a pH value of 7.2 and a particle size of 6066 nm.

Aqueous Polyurethane Aqueous Dispersion 7

23.8 g of polycarbonate polyol 1, 291 g of polytetramethylene ether glycol 2000, 67.5 g of polytetramethylene ether glycol 1000, 4.8 g of dimethylolpropionic acid, 44.8 g of Desmodur® I and 33.9 g of Desmodur® H were mixed at 70° C., heated to 110° C. and stirred at this temperature until the actual NCO value of the prepolymer was less than or equal to the theoretical NCO value. The prepolymer was dissolved in 828.7 g of acetone at 90° C., stirred for 20 minutes and then cooled to 40° C. Then, 3.8 g of ethylenediamine, 15.6 g of sodium 2-[(2-aminoethyl)amino]ethanesulfonate solution and 96.2 g of water were added. After stirring for 20 minutes, 610.6 g of water was further added for dispersion, and the solvent was removed by vacuum distillation to obtain the aqueous polyurethane dispersion 7 having a solid content of 41.4 wt %, a viscosity of 128 mPa·s (23° C.), a pH value of 7.0 and a particle size of 178.1 nm.

Aqueous Polyurethane Aqueous Dispersion 8

47.7 g of polycarbonate polyol 1, 267.3 g of polytetramethylene ether glycol 2000, 67.5 g of polytetramethylene ether glycol 1000, 4.8 g of dimethylolpropionic acid, 44.8 g of Desmodur® I and 33.9 g of Desmodur® H were mixed at 70° C., heated to 110° C. and stirred at this temperature until the actual NCO value of the prepolymer was less than or equal to the theoretical NCO value. The prepolymer was dissolved in 828.7 g of acetone at 90° C., stirred for 20 minutes and then cooled to 40° C. Then, 3.8 g of ethylenediamine, 15.6 g of sodium 2-[(2-aminoethyl)amino]ethanesulfonate solution and 96.2 g of water were added. After stirring for 20 minutes, 610.6 g of water was further added for dispersion, and the solvent was removed by vacuum distillation to obtain the aqueous polyurethane dispersion 8 having a solid content of 41.7 wt %, a viscosity of 40 mPa·s (23° C.), a pH value of 6.8 and a particle size of 178.7 nm.

Comparative Aqueous Polyurethane Aqueous Dispersion 1

175.5 g of polycarbonate polyol 1, 198.6 g of polytetramethylene ether glycol 2000, 86.6 g of polytetramethylene ether glycol 1000, 16.2 g of polyether polyol 2, 56.69 g of Desmodur® I and 46.0 g of Desmodur® H were mixed at 70° C., heated to 120° C. and stirred at this temperature until the actual NCO value of the prepolymer was less than or equal to the theoretical NCO value. The prepolymer was dissolved in 1297.62 g of acetone at 90° C., stirred for 20 minutes and then cooled to 40° C. Then, 1.23 g of hydrazine hydrate, 11.20 g of sodium 2[(2-aminoethyl)amino]ethanesulfonate solution and 30.65 g of water were added. After stirring for 20 minutes, 20.8 g of isophorone diamine and 130.59 g of water were further added. After stirring at 40° C. for 10 minutes, 255.7 g of water was further added for dispersion, and the solvent was removed by vacuum distillation to obtain the comparative aqueous polyurethane dispersion 1 having a solid content of 62.9 wt %, a viscosity of 1740 mPa·s (23° C.), a pH value of 8.5 and a particle size of 482.7 nm.

Comparative Aqueous Polyurethane Aqueous Dispersion 2

238 g of polytetramethylene ether glycol 2000, 51.0 g of polytetramethylene ether glycol 1000, 33.9 g of Desmodur® I and 25.6 g of Desmodur® H were mixed at 70° C., heated to 125° C. and stirred at this temperature until the actual NCO value of the prepolymer was less than or equal to the theoretical NCO value. The prepolymer was dissolved in 619.7 g of acetone at 90° C., stirred for 20 minutes and then cooled to 40° C. Then, 3.4 g of ethylenediamine, 11.6 g of sodium 2[(2-aminoethyl)amino]ethanesulfonate solution and 77.1 g of water were added. After stirring for 20 minutes, 714.3 g of water was further added for dispersion, and the solvent was removed by vacuum distillation to obtain the comparative aqueous polyurethane dispersion 2 having a solid content of 49.8%, a viscosity of 381 mPa·s (23° C.), a pH value of 6.8 and a particle size of 369.5 nm.

Comparative Aqueous Polyurethane Aqueous Dispersion 3

1050 g of polytetramethylene ether glycol 2000, 225.5 g of polytetramethylene ether glycol 1000, 8.1 g of dimethylolpropionic acid, 149.4 g of Desmodur® I and 113.1 g of Desmodur® H were mixed at 70° C., heated to 110° C. and stirred at this temperature until the actual NCO value of the prepolymer was less than or equal to the theoretical NCO value. The prepolymer was dissolved in 2747.7 g of acetone at 90° C., stirred for 20 minutes and then cooled to 40° C. Then, 17.1 g of ethylenediamine, 51.9 g of sodium 2[(2-aminoethyl)amino]ethanesulfonate solution and 361.7 g of water were added. After stirring for 20 minutes, 1548.3 g of water was further added for dispersion, and the solvent was removed by vacuum distillation to obtain the comparative aqueous polyurethane dispersion 3 having a solid content of 46.0 wt %, a viscosity of 994 mPa·s (23° C.), a pH value of 7.1 and a particle size of 224.5 nm.

Comparative Aqueous Polyurethane Aqueous Dispersion 4

157.5 g of polycarbonate polyol 2, 205.6 g of polytetramethylene ether glycol 2000, 115.3 g of polyether polyol 1, 14.6 g of polyether polyol 2, 50.4 g of Desmodur® I and 41.5 g of Desmodur® H were mixed at 70° C., heated to 120° C. and stirred at this temperature until the actual NCO value of the prepolymer was less than or equal to the theoretical NCO value. The prepolymer was dissolved in 1167.7 g of acetone at 90° C., with 7.4 g of a 10% KOH solution added, stirred for 20 minutes and then cooled to 40° C. Then, 1.23 g of hydrazine hydrate, 9.3 g of sodium diaminocarboxylate solution and 22.8 g of water were added. After stirring for 20 minutes, 23.31 g of isophorone diamine and 117.59 g of water were further added. After stirring at 40° C. for 10 minutes, 454.7 g of water was added for dispersion, and the solvent was removed by vacuum distillation to obtain the comparative aqueous polyurethane dispersion 4 having a solid content of 50.5 wt %, a viscosity of 2471 mPa·s (23° C.), a pH value of 8.1 and a particle size of 164.5 nm.

Comparative Aqueous Polyurethane Aqueous Dispersion 5

175.5 g of polycarbonate polyol 1, 198.6 g of polytetramethylene ether glycol 2000, 128.1 g of polyether polyol 1, 16.2 g of polyether polyol 2, 3.1 g of dimethylolpropionic acid, 56.69 g of Desmodur® I and 46.0 g of Desmodur® H were mixed at 70° C., heated to 120° C. and stirred at this temperature until the actual NCO value of the prepolymer was less than or equal to the theoretical NCO value. The prepolymer was dissolved in 1297.62 g of acetone at 90° C., with 7.4 g of a 10% KOH solution added, stirred for 20 minutes and then cooled to 40° C. Then, 1.23 g of hydrazine hydrate, 11.20 g of sodium 2[(2-aminoethyl)amino]ethanesulfonate solution and 30.65 g of water were added. After stirring for 20 minutes, 20.81 g of isophorone diamine and 130.59 g of water were further added. After stirring at 40° C. for 10 minutes, 255.7 g of water was further added for dispersion, and the solvent was removed by vacuum distillation to obtain the comparative aqueous polyurethane dispersion 5 having a solid content of 59.9 wt %, a viscosity of 868 mPa·s (23° C.), a pH value of 7.5 and a particle size of 209.7 nm.

Comparative Aqueous Polyurethane Aqueous Dispersion 6

315 g of polytetramethylene ether glycol 2000, 67.5 g of polytetramethylene ether glycol 1000, 44.8 g of Desmodur® I and 33.9 g of Desmodur® H were mixed at 70° C., heated to 110° C. and stirred at this temperature until the actual NCO value of the prepolymer was less than or equal to the theoretical NCO value. The prepolymer was dissolved in 819.7 g of acetone at 90° C., stirred for 20 minutes and then cooled to 40° C. Then, 3.8 g of ethylenediamine, 15.6 g of sodium 2[(2-aminoethyl)amino]ethanesulfonate solution, 9.5 g of a 50% aqueous solution of 2,6-diaminohexanoic acid and 96.2 g of water were added. After stirring for 20 minutes, 605.6 g of water was added for dispersion, and the solvent was removed by vacuum distillation to obtain the comparative aqueous polyurethane dispersion 6 having a solid content of 41.6 wt %, a viscosity of 30 mPa·s (23° C.), a pH value of 6.7 and a particle size of 509.7 nm.

Comparative Aqueous Polyurethane Aqueous Dispersion 7

315 g of polyether polyol 1, 67.5 g of polytetramethylene ether glycol 1000, 4.8 g of dimethylolpropionic acid, 44.8 g of Desmodur® I and 33.9 g of Desmodur® H were mixed at 70° C., heated to 110° C. and stirred at this temperature until the actual NCO value of the prepolymer was less than or equal to the theoretical NCO value. The prepolymer was dissolved in 828.7 g of acetone at 90° C., stirred for 20 minutes and then cooled to 40° C. Then, 3.8 g of ethylenediamine, 15.6 g of sodium 2[(2-aminoethyl)amino]ethanesulfonate solution and 96.2 g of water were added. After stirring for 20 minutes, 610.6 g of water was further added for dispersion, and the solvent was removed by vacuum distillation to obtain the comparative aqueous polyurethane dispersion 7 having a solid content of 41.1 wt %, a viscosity of 201 mPa·s (23° C.), a pH value of 7.05 and a particle size of 162.7 nm.

Preparation of Coating Compositions of Examples 1-8 and Comparative Examples 1-7

Composition of the coating composition: 92 parts by weight of an aqueous polyurethane dispersion, 3 parts by weight of Imprafix® 2794 and 5 parts by weight of Desmodur® 2802.

According to the above composition, the components were uniformly mixed to obtain the coating compositions of Examples 1-8 and Comparative Examples 1-7, wherein the aqueous polyurethane dispersion in the coating composition of Example 1 was the aqueous polyurethane dispersion 1, the aqueous polyurethane dispersion in the coating composition of Example 2 was the aqueous polyurethane dispersion 2, and so on. The viscosity of the coating compositions was adjusted by Borchi Gel ALA to be 4500 mPa·s for use.

Film-Forming Process of a Coating Composition and Method for Film Performance Test

Step 1. The coating compositions of Examples and Comparative Examples were separately applied by means of blade coating with a film scraper onto an even and smooth surface to produce a wet film having a thickness of 500 μm, which was dried at 50° C. for 30 minutes and then at 150° C. for 3 minutes to obtain a dry film sample.

Step 2. Half of the dry film was used to cut a piece of 5 cm*2 cm, the thickness and weight of which was measured. The thickness of the film sample was recorded as T₀.

Step 3. The dry film was weighed and then put into a dyeing cup for test, and a NaOH solution having a concentration of 1.5% and a weight that is 15 times the weight of the film was added to the cup. It was put into a dyeing machine used for laboratory small samples and hot alkali treatment was carried out under the process conditions as follows:

The temperature was increased from room temperature to 90° C. at a heating rate of 4° C./min, maintained at 90° C. for 15 minutes, and then decreased from 90° C. to 50° C. at a cooling rate of 3° C./min. The dyeing machine used for laboratory small samples is Model DYE-24, available from Shanghai Qianli Automation Equipment Co., Ltd.

Step 4. After the conditions of hot alkali treatment were completed, the film was taken out and cleaned (it was not necessary to carry out subsequent steps if the film was broken at this step), and dried with paper. The film was put into a dyeing cup for test again, and a acetic acid solution having a pH value of 4 and a weight that is 15 times the weight of the film was added to the cup. It was put into a dyeing machine used for laboratory small samples and hot acid treatment was carried out under the process conditions as follows:

The temperature was increased from room temperature to 80° C. at a heating rate of 3° C./min, from 80° C. to 130° C. at a heating rate of 1° C./min, maintained at 130° C. for 40 minutes, and then decreased from 130° C. to 80° C. at a cooling rate of 1° C./min, finally from 80° C. to 50° C. at a cooling rate of 3° C./min.

Step 5. After the conditions of hot acid treatment were completed, the film was taken out and cleaned, and the length, width and thickness of the film were measured and recorded respectively as length L₁, width W₁ and thickness T₁ of the film sample after treatment. Swelling ratio R was calculated according to the following formula:

R=(L₁*W₁*T₁/(5*2*T₀))*100%−1

Swelling ratio is an important index for evaluating the acid and alkali resistance of a film. The lower the swelling ratio is, the higher the acid and alkali resistance is. The desired swelling ratio in the industry is less than 32%.

Step 6. The dry film obtained in the step 1 was made into a dumbbell shape, and the 100% modulus, tensile strength at break and elongation at break were tested according to standard DIN 53504 at standard atmospheric pressure, room temperature of 23° C. and a relative humidity of 50%.

The higher the 100% modulus, tensile strength at break and elongation at break are, the better the mechanical properties of the film are. It is suitable in the industry that the 100% modulus is not less than 2.5 N/mm², the tensile strength at break is not less than 20 N/mm², and the elongation at break is greater than 580%.

Film Test Results

Table 1 lists the results of various tests of the films formed by the coating compositions of Examples 1-8 and Comparative Examples 1-7.

TABLE 1
film test results

| Example/ | Tensile | | 100% | |
|---|---|---|---|---|
| Comparative | strength at | Elongation | Modulus/ | Swelling |
| Example | break/N/mm² | at break/% | N/mm² | ratio R/% |
| Example 1 | 22 | 588 | 2.7 | 24.9 |
| Example 2 | 26.1 | 664 | 2.7 | 31.1 |
| Example 3 | 26.1 | 615 | 3.1 | 22.7 |
| Example 4 | 33.2 | 655 | 2.9 | 21.5 |
| Example 5 | 35.7 | 720 | 2.7 | 16.2 |
| Example 6 | 26.2 | 703 | 2.8 | 13.9 |
| Example 7 | 22.4 | 657 | 2.5 | 27.8 |
| Example 8 | 20.7 | 616 | 2.6 | 31.1 |
| Comparative | 16.7 | 607 | 2.2 | The film is |
| Example 1 | | | | fully |
| | | | | destructed |
| | | | | and |
| | | | | incomplete |
| Comparative | 21 | 1050 | 1.6 | 54.9 |
| Example 2 | | | | |
| Comparative | 26.1 | 743.2 | 1.8 | 86.4 |
| Example 3 | | | | |
| Comparative | 14.1 | 857.8 | 1.3 | 85.4 |
| Example 4 | | | | |
| Comparative | 22.3 | 1044 | 1.4 | 174.7 |
| Example 5 | | | | |
| Comparative | 5.3 | 718 | 0.94 | 173.7 |
| Example 6 | | | | |
| Comparative | 6.9 | 778 | 0.92 | 92.3 |
| Example 7 | | | | |

It can be seen from Examples 1-8 and Comparative Examples 1-7 that all of the films formed by the coating compositions of Examples 1-8 have a swelling ratio of less than 32%, which is far less than that of the Comparative Examples, which indicating that the films formed by the coating compositions of Example 1-8 have good acid and alkali resistance, especially acid and base resistance under high temperature. Besides, all of the films formed by the coating compositions of Example 1-8 have a 100% modulus of not less than 2.5 N/mm², a tensile strength at break of not less than 20 N/mm², and an elongation at break of greater than 580%, indicating that the films formed by the coating compositions of Examples 1-8 have good mechanical properties.

In Comparative Examples 1 and 2, the systems for preparing the comparative aqueous polyurethane dispersions do not comprise any anionic or potentially anionic hydrophilic agent having a number average molecular weight of 32 g/mol to 400 g/mol and containing hydroxyl and carboxyl functions. Afteracid and alkali treatment at higher temperature, the films formed by the comparative coating compositions comprising the comparative aqueous polyurethane dispersions have a swelling ratio of much higher than 32% or even the films are broken, that is, the films formed by the comparative coating compositions do not achieve good acid and alkali resistance. Moreover, the films formed by the comparative coating compositions have a 100% modulus of less than 2.5 N/mm², that is, the films formed by the comparative coating compositions do not have good mechanical properties.

In the system for preparing the comparative aqueous polyurethane dispersion of Comparative Example 3, the weight of the anionic or potentially anionic hydrophilic agent having a number average molecular weight of 32 g/mol to 400 g/mol and containing hydroxyl and carboxyl functions amounts to less than 20% of the weight of the hydrophilic agents of the system. In Comparative Example 6, the system for preparing the comparative aqueous polyurethane dispersion merely comprises an amino acid, but not an anionic or potentially anionic hydrophilic agent containing hydroxyl and carboxyl functions. After hot acid and hot alkali treatment, the film formed by the comparative coating composition comprising the comparative aqueous polyurethane dispersion of Comparative Example 3 or Comparative Example 6 has a swelling ratio of greater than 32%, indicating the film formed by the comparative coating composition does not have good acid and alkali resistance. Moreover, the films formed by the comparative coating compositions have a 100% modulus of less than 2.5 N/mm², that is, the films formed by the comparative coating compositions do not have good mechanical properties.

In Comparative Examples 4 and 5, the systems for preparing the comparative aqueous polyurethane dispersions do not comprise any polytetramethylene ether glycols having a number average molecular weight of not more than 1500 g/mol. After hot acid and hot alkali treatment, the film formed by the comparative coating composition comprising the comparative aqueous polyurethane dispersion of Comparative Example 4 or 5 has a swelling ratio of greater than 32%, indicating the film formed by the comparative coating composition does not have good acid and alkali resistance. Moreover, the films formed by the comparative coating compositions have a 100% modulus of less than 2.5 N/mm², that is, the films formed by the comparative coating compositions do not have good mechanical properties.

In Comparative Example 7, the system for preparing the comparative aqueous polyurethane dispersion do not comprise any polytetramethylene ether glycols having a number average molecular weight of more than 1500 g/mol. After hot acid and hot alkali treatment, the film formed by the comparative coating composition comprising the comparative aqueous polyurethane dispersion of Comparative Example 7 has a swelling ratio of greater than 32%, indicating the film formed by the comparative coating composition does not have good acid and alkali resistance. Moreover, the film formed by the comparative coating composition has a 100% modulus of less than 2.5 N/mm² and a tensile strength at break of less than 20 N/mm², that is, the films formed by the comparative coating composition does not have good mechanical properties.

It is apparent to those skilled in the art that the present invention is not limited to the specific details described above, and may be embodied in other specific forms without departing from the spirit or essential characteristics according to the present invention. The Examples are to be considered in all respects as illustrative but not restrictive, so that the scope according to the present invention is defined by the claims rather than the foregoing description. Thus, any change, as long as it belongs to the meaning and range of equivalents of the claims, should be considered as part of this invention.

1. An aqueous polyurethane dispersion comprising a polyurethane obtained by reacting a system comprising the following components:
A1) at least one polyisocyanate having an isocyanate functionality of not less than 2;
A2) at least two different polytetramethylene ether glycols A2a) and A2b), the A2a) having a number average molecular weight of not more than 1500 g/mol, the A2b) having a number average molecular weight of more than 1500 g/mol; and
A3) at least one anionic or potentially anionic hydrophilic agent having a number average molecular weight of 32 g/mol to 400 g/mol and containing hydroxyl and carboxyl functions;
B) at least one amino-functional anionic or potentially anionic hydrophilic agent;
C) at least one amino-functional compound having a number average molecular weight of 32 g/mol to 400 g/mol and containing no hydrophilic group; and
D) optionally a neutralizer;
wherein the ratio of the number average molecular weight of the A2a) to the number average molecular weight of the A2b) is 1:9 to less than 1:1, and the weight of the A3) anionic or potentially anionic hydrophilic agent having a number average molecular weight of 32 g/mol to 400 g/mol and containing hydroxyl and carboxyl functions amounts to 20% to 70% of the weight of the hydrophilic agents of the system, wherein the hydrophilic agents of the system are components A3 and B.

2. The dispersion according to claim 1, wherein the A1) polyisocyanate is one or more of the followings: an aliphatic polyisocyanate and an alicyclic polyisocyanate.

3. The dispersion according to claim 1, wherein the A1) polyisocyanate is one or more of the followings: hexamethylene diisocyanate and isophorone diisocyanate.

4. The dispersion according to claim 1, wherein the A2a) has a number average molecular weight of 400 g/mol to 1500 g/mol.

5. The dispersion according to claim 1, wherein the A2b) has a number average molecular weight of more than 1500 g/mol and less than or equal to 8000 g/mol.

6. The dispersion according to claim 1, wherein the A3) anionic or potentially anionic hydrophilic agent having a number average molecular weight of 32 g/mol to 400 g/mol and containing hydroxyl and carboxyl functions is dimethylolpropionic acid.

7. The dispersion according to claim 1, wherein the ratio of the number average molecular weight of the A2a) to the number average molecular weight of the A2b) is 1:4 to less than 1:1.

8. The dispersion according to claim 1, wherein the weight of the A3) anionic or potentially anionic hydrophilic agent having a number average molecular weight of 32 g/mol to 400 g/mol and containing hydroxyl and carboxyl functions amounts to 20% to 60% of the weight of the hydrophilic agents of the system.

9. The dispersion according to claim 1, wherein the B) amino-functional anionic or potentially anionic hydrophilic agent is sodium 2-[(2-aminoethyl)amino]ethanesulfonate.

10. The dispersion according to claim 1, wherein the D) neutralizer has a molar amount of less than or equal to 50 mol %, based on the molar amount of the A3) anionic or potentially anionic hydrophilic agent having a number average molecular weight of 32 g/mol to 400 g/mol and containing hydroxyl and carboxyl groups as 100 mol %.

11. A method for preparing an aqueous polyurethane dispersion of claim 1, comprising the steps of:
I) mixing and reacting A1) at least one polyisocyanate having an isocyanate functionality of not less than 2; A2) at least two different polytetramethylene ether glycols A2a) and A2b), the A2a) having a number average molecular weight of not more than 1500 g/mol, the A2b) having a number average molecular weight of more than 1500 g/mol; and A3) at least one anionic or potentially anionic hydrophilic agent having a number average molecular weight of 32 g/mol to 400 g/mol and containing hydroxyl and carboxyl functions to obtain an isocyanate-functional prepolymer;
II) reacting the isocyanate-functional prepolymer, B) at least one amino-functional anionic or potentially anionic hydrophilic agent, C) at least one amino-functional compound having a number average molecular weight of 32 g/mol to 400 g/mol and containing no hydrophilic group and D) an optional neutralizer to obtain a polyurethane; and
III) introducing water before, during or after step II) to obtain the aqueous polyurethane dispersion.

12. A product comprising an aqueous polyurethane dispersion according to claim 1.

13. The product according to claim 12, wherein the product is selected from the group consisting of a coating composition, an impregnating composition, an adhesive, and a sealant.

14-15. (canceled)

16. An article comprising a substrate prepared, coated, impregnated, bonded or sealed with an aqueous polyurethane dispersion according to claim 1.

17. The article according to claim 16, wherein the substrate is fiber-based.

18. The article according to claim 16, wherein the article is synthetic leather.

19. The dispersion according to claim 1, wherein the weight of the A3) anionic or potentially anionic hydrophilic agent having a number average molecular weight of 32 g/mol to 400 g/mol and containing hydroxyl and carboxyl functions amounts to 20% to 35% of the weight of the hydrophilic agents of the system.

20. The dispersion according to claim 1, wherein the weight of the A3) anionic or potentially anionic hydrophilic agent having a number average molecular weight of 32 g/mol to 400 g/mol and containing hydroxyl and carboxyl functions amounts to 20% to 30% of the weight of the hydrophilic agents of the system.

21. The dispersion according to claim 1, wherein the D) neutralizer has a molar amount of less than or equal to 30 mol %, based on the molar amount of the A3) anionic or potentially anionic hydrophilic agent having a number average molecular weight of 32 g/mol to 400 g/mol and containing hydroxyl and carboxyl groups as 100 mol %.
